(19) United States
(12) Patent Application Publication
(10) Pub. No.: US 2025/0209307 A1
(43) Pub. Date: Jun. 26, 2025

(54) System and Method for Multiple Concurrent Interactive Sessions Using Generative Artificial Intelligence

(71) Applicant: Google LLC, Mountain View, CA (US)

(72) Inventors: Jennifer Su, Irvine, CA (US); Zhiyu Bai, Kirkland, WA (US); Michael Kirby, Fallbrook, CA (US); Kevin Pang, North Tustin, CA (US); Anila Alexander, New York, NY (US); Andrei Barysiuk, Rancho Mission Viejo, CA (US); Wenhao Cen, Yorba Linda, CA (US)

(21) Appl. No.: 18/392,089

(22) Filed: Dec. 21, 2023

Related U.S. Application Data
(60) Provisional application No. 63/529,896, filed on Jul. 31, 2023.

(51) Int. Cl. G06N 3/0455; G06N 3/006; G06N 3/08

(52) U.S. Cl. CPC G06N 3/0455; G06N 3/006; G06N 3/08

(57) ABSTRACT

The technology is generally directed to concurrently conducting multiple interactive sessions. The interactive sessions may be electronic communication sessions, such as chats, configured to transmit and receive content among the participants of the interactive sessions. The interactive sessions may be established in response to receiving content from respective users. A predicted response may be identified, or generated, by a first machine learning model trained to provide predicted responses based on the received content. The predicted responses may be automatically transmitted to the user if no manual input from an agent is received within a threshold period of time. In some examples, in response to the received content, a second machine learning model may determine whether to transmit a notification to the agent. The notification may be a request for agent intervention such that the agent subsequently provides one or more manual inputs from the agent rather than the predicted response.

### CROSS REFERENCE TO RELATED APPLICATIONS

This application claims the benefit of the filing date of U.S. Provisional Patent Application No. 63/529,896 filed Jul. 31, 2023, the disclosure of which is hereby incorporated herein by reference.

### BACKGROUND

Typically, agents overseeing interactive sessions, or chats, oversee a single chat rather than multiple chats concurrently. The chats can use generative artificial intelligence (“AI”) to provide responses to a user request. The agent typically has to review the response generated by the AI before providing an input to transmit the response to the user. This prevents the agent from being able to oversee multiple chats occurring at once. Further, typical user interfaces are not configured to support multiple chats. Rather, the typical user interface provides for output a single chat such that the agent can see what is happening in that chat at all times. The constant review and approval of responses generated by AI is time consuming and prevents the agent from being able to oversee multiple chats.

### BRIEF SUMMARY

The technology is generally directed to using generative AI to facilitate multiple interactive sessions between one agent and multiple users concurrently. The interactive sessions may be electronic communication sessions, such as chats, configured to transmit and receive content among the participants of the interactive sessions. The interactive sessions may be established in response to receiving content from respective users. A predicted response may be identified, or generated, by generative AI trained to provide predicted responses based on the received content. The predicted responses may be automatically transmitted to the user if no manual input from the agent is received within a threshold period of time. In some examples, in response to the received content, a second machine learning model may determine whether to transmit a notification to the agent. The notification may be a request for agent intervention such that the agent subsequently provides one or more manual inputs rather than the predicted response.

One aspect of the disclosure is directed to a method comprising receiving, by one or more processors, content from a plurality of users, generating, by the one or more processors, a respective interaction window for each of the plurality of users, wherein each respective interaction window corresponds to a respective interactive session, identifying, by the one or more processors executing a first machine learning model based on the received content, a predicted response for each interactive session, determining, by the one or more processors prior to transmitting the predicted response, if a manual input from an agent is received, and automatically transmitting, by the one or more processors after a threshold period of time if the manual input from the agent is not received, the predicted response for each interactive session, wherein the automatically transmitting occurs with respect to multiple interactive sessions concurrently.

The respective interaction window may include a timer element in relation to the predicted response. The timer element may provide an indication of a remaining amount of time of the threshold period of time before the predicted response is automatically transmitted.

The respective interactive session may correspond to an electronic communication session among two or more of a respective user, the machine learning model, or an agent. The respective interaction windows for each of the plurality of users may be provided for output on one or more displays coupled to an agent computing device. The respective interactive windows may be cascaded in a panel of the single display.

A visible portion of the respective interaction windows may include a timer and an identifier of the respective user. The timer may provide an indication of an elapsed time since a previous response was transmitted to a respective user or an elapsed time from when content was received from the respective user. The previous response may be the predicted response or the manual input from the agent.

The method may further comprise automatically identifying, by the one or more processors executing a second machine learning model, whether to transmit a notification to an agent. The notification may be an audible or visual notification. The notification may be a request for agent intervention. The agent intervention may correspond to one or more manual inputs from the agent in response to the received content from a respective user.

The method may further comprise terminating, by one or more processors executing the machine learning model based on the received content, the respective interactive session. The method may further comprise providing, by the one or more processors as input into the first or second machine learning model, contents of the respective interaction session. The method may further comprise updating, by the one or more processors based on the contents of the respective interactive session, the first or second machine learning model. The contents of the respective interactive session may include an indication of when the manual input from the agent was transmitted instead of the predicted response.

Another aspect of the disclosure is directed to a system comprising one or more processors. The one or more processors may be configured to receive content from a plurality of users, generate a respective interaction window for each of the plurality of users, wherein each respective interaction window corresponds to a respective interactive session, identify, by executing a first machine learning model based on the received content, a predicted response for each interactive session, determine, prior to transmitting the predicted response, if a manual input from an agent is received, and automatically transmit, processors after a threshold period of time if the manual input from the agent is not received, the predicted response for each interactive session, wherein the automatically transmitting occurs with respect to multiple interactive sessions concurrently.

Yet another aspect of the disclosure is directed to one or more non-transitory computer-readable storage media encoding instructions that, when executed by one or more processors, cause the one or more processors to perform operations comprising receiving content from a plurality of users, generating a respective interaction window for each of the plurality of users, wherein each respective interaction window corresponds to a respective interactive session, identifying, by executing a first machine learning model based on the received content, a predicted response for each interactive session, determining, prior to transmitting the predicted response, if a manual input from an agent is received, and automatically transmitting, processors after a threshold period of time if the manual input from the agent is not received, the predicted response for each interactive session, wherein the automatically transmitting occurs with respect to multiple interactive sessions concurrently.

### BRIEF DESCRIPTION OF THE DRAWINGS

FIG. 1 is a screenshot illustrating an example user interface according to aspects of the disclosure.

FIG. 2 is a block diagram of an example system for generating and engaging with the interaction windows according to aspects of the disclosure.

FIG. 3 is a block diagram of an example generative response system according to aspects of the disclosure.

FIGS. 4A-4C are screenshots illustrating example predicted responses according to aspects of the disclosure.

FIGS. 5A-5B are screenshots illustrating example interaction window headers according to aspects of the disclosure.

FIG. 6 is a block diagram of an example notification system according to aspects of the disclosure.

FIGS. 7A-7B are screenshots illustrating example timers according to aspects of the disclosure.

FIGS. 8A-8B are screenshots illustrating example termination of interactive sessions according to aspects of the disclosure.

FIG. 9A is a screenshot illustrating an example interaction window panel according to aspects of the disclosure.

FIG. 9B is a screenshot illustrating another example interaction window panel according to aspects of the disclosure.

FIG. 10 is a screenshot illustrating an example user interface for concurrent interactive sessions according to aspects of the disclosure.

FIG. 11A is a screenshot illustrating an example user interface for requesting a consult according to aspects of the disclosure.

FIG. 11B is a screenshot illustrating an example of concurrent interactive sessions including a consult according to aspects of the disclosure.

FIG. 12 is a block diagram of an example system according to aspects of the disclosure.

FIG. 13 is an example method of concurrently conducting multiple interactive sessions according to aspects of the disclosure.

### DETAILED DESCRIPTION

The technology is generally directed to concurrently conducting multiple interactive sessions between a single agent and a plurality of users. The single agent is able to oversee the multiple interactive sessions through the use of generative AI configured to predict responses to content provided by a respective user. Further, the single agent is able to oversee the multiple interactive sessions, concurrently, through the use of AI to provide notifications to alert the agent when to intervene in a particular interactive session.

The interactive session may be an electronic communication session, or a chat session, between a respective user and the agent. The agent may be overseeing multiple interactive sessions concurrently. The generative AI model may be trained to provide predictive responses to the content received by the user for a given interactive session. The generative AI may, in some examples, be a ML model. A plurality of interactive sessions may occur concurrently using the generative AI, such that the generative AI provides individualized predicted responses for each interactive communication session based on the content received from the user of the respective interactive session. The predicted responses provided by the generative AI as output provide conversational and interactive responses to the specific content provided by the user. The predicted responses may be transmitted automatically if an agent input is not received within a threshold period of time from the generation of the predicted response.

By using generative AI to predict responses, an agent may oversee a plurality of interactive sessions simultaneously as opposed to overseeing a single interactive session at a time. For example, the use of AI may automate actions and workflows within the interactive sessions thereby reducing the need for agent interaction with the interactive sessions. Further, the use of AI may allow for the number of interactive sessions that can be managed concurrently to increase without interfering or reducing the quality and effectiveness of the interactive sessions. For example, the predicted responses provided by the generative AI, the threshold period of time for waiting for an agent input prior to transmitting the predicted responses, and other features may result in a natural conversation between the user and the generative AI, in lieu of the agent, such that the user is unaware that their interactions are with AI rather than a human.

The threshold waiting period, in some examples, may correspond to a buffer time to avoid giving full control to the AI system when responding to users. This threshold waiting period, therefore, prevents the AI system from acting without user oversight.

According to some examples, an artificial intelligence (“AI”) model, such as a machine learning (“ML”) model, may be trained to provide a notification to the agent based on the content received from the user. The AI model may be, for example, a notification system. For example, if the content includes a request to speak to an agent, to access account information, or the like, the AI model may transmit a notification to the agent. In some examples, if the AI model cannot generate a response to the content, cannot access information responsive to the content, or the like, the AI model may transmit a notification to the agent. The notification may be, in some examples, visual or audible. For example, each interactive session that is occurring simultaneously may include a header. The notification may cause the header of the respective interactive session to flash, blink, change colors, or the like. Additionally or alternatively, the notification may be audible, haptic, etc. and draw the attention of the agent to the respective interaction session.

In some examples, when a notification is transmitted to the agent, the agent may intervene, such as by providing a manual input in response to the content received from the user. Such intervention may be used to update the second AI model, e.g., the notification system. For example, the manual input in response to a notification may be used as training data to update the notification system. The training data may include an indication of why the notification was sent, why the agent intervened in the interactive session, when the agent intervened, what the context of the intervention was, or the like. The content of the intervention may be, for example, the timing in the interactive session, text, request, etc. The training data may be used to update the notification system to determine one or more additional notifications. According to some examples, updating the system based on details regarding an agent's intervention in the interactive session may increase the computational efficiency of the system. For example, by using the details associated with why a notification was sent, why an agent intervened in an interactive session, when an agent intervened, what the context of the intervention was, etc., the AI model may be updated to more accurately predict when a notification is necessary or more appropriate. By sending a notification at an earlier time, in response to certain content, or the like, the use of computational resources of the system decreases by reducing the number of messages being transmitted in the interactive session. For example, by sending the notification to the agent to intervene at a more appropriate or accurate time during the interactive session, the user may no longer have to send a plurality of messages and/or receive a plurality of unresponsive messages via the interactive session. This can dramatically reduce the number of messages when large numbers of messages need to be processed at the same time by the system, when an extensive number of chats is run in parallel, thereby reducing processing power, network overhead, and other system resources. As a large number of chats can be run in parallel by a single agent, a reduction in messages exchanged by all parties involved in the interactive session can improve the functioning of the system. For example, by reducing the number of messages exchanged by all parties involved in the interactive session, the efficiency of the system is increased by reducing the processing power, network overhead, and other system resources.

The notifications may allow for an agent to simultaneously oversee a plurality of interactive sessions as the notification will alert the agent to the interactive session that requires an agent input while the generative AI continues to predict and, in some examples, transmit responses to the content received from the user.

Using generative AI, e.g., the predicted response system, to provide predicted responses to content received from the user and an AI model to provide notifications to an agent to intervene in the interactive session may allow for a plurality of efficient and effective interactive sessions to occur concurrently while being overseen by a single agent. In particular, the agent may continue to control and supervise the AI predicted responses while saving time and increasing productivity by intervening only when the AI model, e.g., the notification system, provides a notification to do so. The AI models may, therefore, allow a single agent to supervise a plurality of interactive sessions based, in part, to the predicted responses provided by the generative AI, e.g., the predicted response system, and the notifications to intervene provided by the AI model, e.g., the notification system.

According to some examples, by increasing the number of concurrent interactive sessions being overseen by a single agent, the computational efficiency of the system may increase by decreasing the amount of processing power and network overhead to conduct the interactive sessions. The amount of processing power and network overhead may be decreased by reducing the number of computer systems having to run concurrently, e.g., by no longer having to have a single computing system per interactive session. Rather, the processing power and network overhead is reduced by having a single computing system capable of handling a plurality of interactive sessions running concurrently.

This disclosure describes techniques for enabling artificial intelligence to provide predicted responses during an interactive session and identify whether to transmit a notification to alert an agent to intervene in the interactive session. Artificial intelligence (AI) is a segment of computer science that focuses on the creation of intelligent agents that can learn and act autonomously (e.g., without human intervention). Artificial intelligence systems can utilize one or more of (i) machine learning, which focuses on developing algorithms that can learn from data, (ii) natural language processing, which focuses on understanding and generating human language, and/or (iii) computer vision, which is a field that focuses on understanding and interpreting images and videos. Artificial intelligence systems can include generative models that generate new content (e.g., images/video, text, audio, or other content) in response to input prompts.

Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The model(s) can be trained using various training or learning techniques. The training can implement supervised learning, unsupervised learning, reinforcement learning, etc. The training can use techniques such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. A number of generalization techniques (e.g., weight decays, dropouts, etc.) can be used to improve the generalization capability of the models being trained.

The model(s) can be pre-trained before domain-specific alignment. For instance, a model can be pretrained over a general corpus of training data and fine-tuned on a more targeted corpus of training data. A model can be aligned using prompts that are designed to elicit domain-specific outputs. Prompts can be designed to include learned prompt values (e.g., soft prompts). The trained model(s) may be validated prior to their use using input data other than the training data, and may be further updated or refined during their use based on additional feedback/inputs.

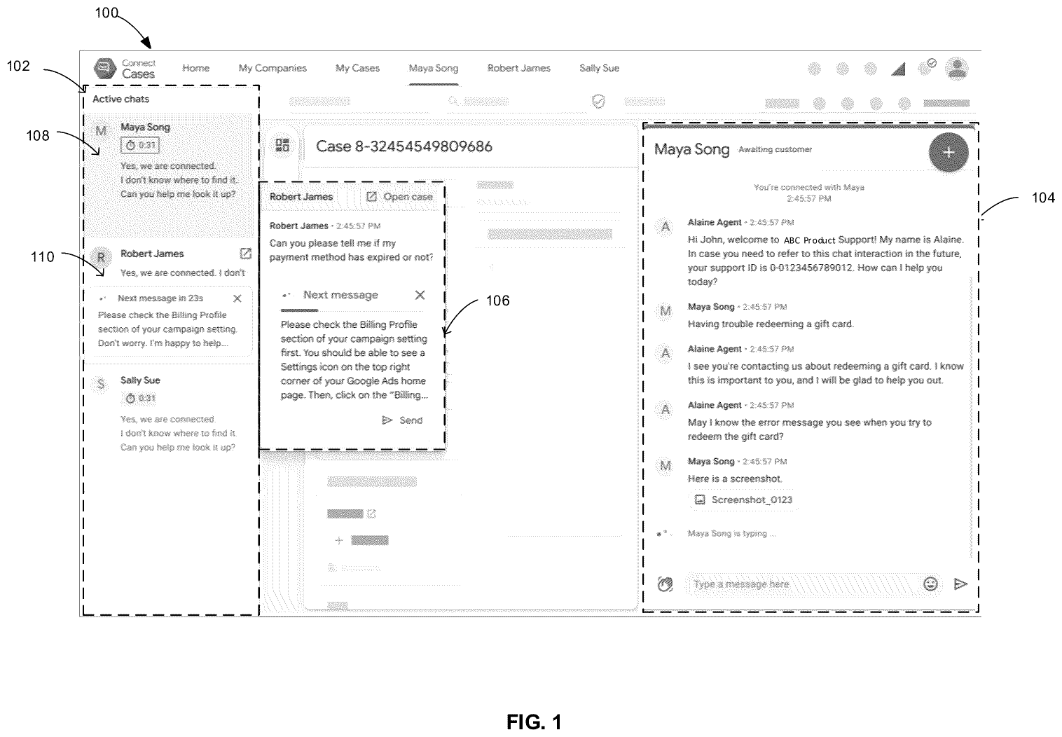

FIG. 1 illustrates a screenshot of an example interface for utilizing AI to concurrently conduct multiple interactive sessions while requiring only a single agent to oversee the multiple sessions. The interface 100 may include one or more panels, such as interaction window panel 102, chat panel 104, an overview panel, etc. The interaction window panel 102 may include a plurality of interaction windows. For example, as shown in FIG. 1, there are two interactive windows 108, 110. Each interaction window may correspond to an interactive session. The interactive session may be a communication session between a user and the agent. In some examples, at least a portion of the interactive session may be a communication session between the user and the AI, in lieu of the agent.

According to some examples, when the interface 100 receives an input corresponding to a selection of an interaction window 108, 110 an interactive session may be provided as a pop-up 106 or overlay on the interface 100. The interactive session may be a communication interface configured to allow for communication among the user, AI, and the agent. According to some examples, the interactive sessions may be provided as cascaded windows in chat panel 104. The interactive session provided for output in the chat panel 104 may be the same or different from the interactive session provided for output as pop-up 106. By having different interactive sessions in each of the chat panel 104 and pop-up 106, the agent may oversee and/or interact with a plurality of interactive sessions concurrently without having to switch interfaces, windows, computers, etc. This may increase computational efficiency by reducing the amount of processing power and network overhead by allowing the agent to engage with a plurality of users concurrently, without having to have multiple interfaces, computer systems, or the like running concurrently.

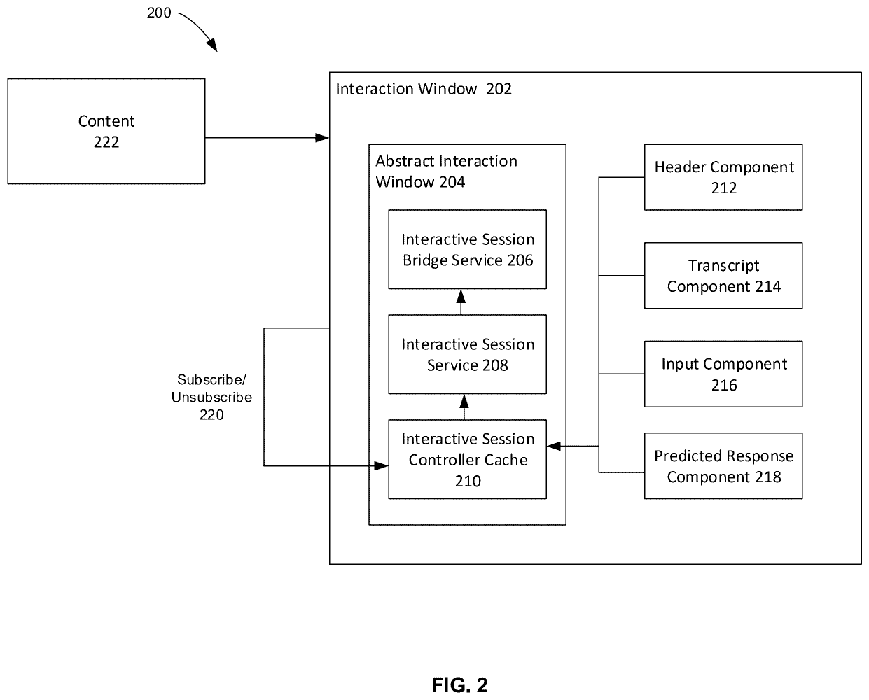

FIG. 2 illustrates an example system for generating the interactive sessions. The system 200 may receive content 222 from a user. The content 222 may be, for example, text and/or images. According to some examples, the content 222 may be a question or request, such as “Can you provide me with a status on my order?” or “I need help accessing my user account.” The system 200 may generate an interaction window 202 in response to receiving the content. The interaction window 202 may correspond to an interaction session, such as an electronic communication session among the user, the agent, and AI.

The interaction window 202 may include an abstract interaction window 204. The abstract interaction window 204 may include conversation bridge service 206, interactive session service 208, and conversation controller cache. The bridge may be a bridge between the user interface and an API.

According to some examples, bridge protocol buffers may be generated by the system 200. According to some examples, the protocol buffers may encode structured data in an efficient yet extensible format. For example, each field of the content may include a data type, tag, name, etc. A protocol-compiler may generate code that constructs and parses the content, produces human-readable dumps, or the like. According to some examples, bridge protocol buffers may generate services required for the interaction windows based on the use case of the interface, e.g., customer support. The bridge protocol buffers and their generated services may be reused by other bridge servers for other user cases, e.g., sales. Extensibility in the frontend components may be provided where appropriate to provide sufficient customization for all currently known and anticipated application specific use cases. The components may include one or more of a header component 212, transcript component 214, input component 216, and predicted response component 218.

According to some examples, an AI model may be used to identify, provide for output, and/or store the state of all active interactive sessions an agent is engaged in. For example, a controller may be configured to sync the AI model used to identify the state of the interactive session with the state of the database.

In some examples, a bridge protocol buffer may be created to identify information, or data, on the interactive session tangle entity, all participant entities, and the automated flow entities of the interactive session. Participant entities may include, for example, model representation for all participants in an interactive session. The participants may be, for example, the user, the agent, or the like. Automated flow entities may include, for example, model representation for agent supervised automation in the conversation. The model may contain the step configuration that determines how the automation in the interactive session will proceed. For example, the model may determine whether to send a predetermined response, an AI generated message, ending the chat, etc.

In some examples, a bridge protocol buffers may be generated to identify event data for an interactive session. For example, a first layer may have an event entity that stores common event data. A separate entity may store information related to specific types of events. The bridge conversation event entity may consolidate the individual entities into a single entity. Common fields may be added to the combined entity and used to create and/or update interactive session events. The interactive session events may be used throughout the life cycle, or lifetime, of the interactive session. The interactive session events may include, for example, when content is being transmitted and/or received by the user or agent, when content is being transmitted as part of an automated flow, an intervention from the agent, etc.

Interactive session service 208 may be configured to expose one or more additional features of the application programming interface (“API”) for interface 100. The API may include, for example, a bridge between the interface and the API configured to fetch a specific interactive session and return a model of the interactive session if it exists, a bridge between the interface and the API configured to fetch interactive session events, a bridge between the interface and the API configured to insert a completed interactive session event into a text box to be transmitted as content, a bridge between the interface and the API configured to insert a completed interactive session event into a text box to be transmitted as content to terminate the interactive session, a bridge between the interface and the API configured to insert a completed interactive session event including joint event data. Completed interactive session events may be, for example, events in which common interactive session event metadata has been filled out, e.g., provided. Event metadata may include, for example, an identification of the participant that triggered the interactive session event, whether an automated flow was used to trigger the interactive session event, ids and text for components of the interactive session event that were provided by AI, among other ids and timestamps needed by the system.

Interactive session controller cache 210 may be configured for tracking interactive sessions in memory. The system 200 may store and/or track interactive sessions after confirming the users have provided authorization for the interactive session to be stored and/or tracked. The contents of the interactive sessions may be determined and used after the user provides authorization for the system 200 to access and receive information related to the interactive session the user participated in. For example, the user may provide authorization to a website, application, or system when participating in an interactive session. The authorization may be for the application to system to access, store, track, or the like the contents of the interactive session.

According to some examples, the interactive session controller cache 210 may be configured as a pass through for content being transmitted to interactive session service 208. In such an example, interactive session controller cache 210 may add logic and/or local event handling on an as needed basis.

In some examples, the interactive session controller cache 210 may be configured to generate, store, and/or provide an identifier of respective interactive sessions. Each component of system 200 may use the identifier throughout a lifecycle of an interactive session.

The interactive session controller cache 210 may be configured to subscribe/unsubscribe 220 interactive sessions to memory. For example, subscribing an interactive session to memory may include loading contents of an interactive session into memory and updating the contents with the storage layer. The contents may include, for example, any content that was transmitted and/or received by the system, events associated with the interactive session, typing status of the user, agent, or AI models, or the like. The interactive session controller cache 210 may be configured to keep the interactive session model in sync by reloading at least a portion of the interactive session for each invalidation type.

Unsubscribing the interactive session may include, for example, removing the contents and/or associated interactive session model from memory. According to some examples, the interactive session controller cache 210 may be configured to unsubscribe from an interactive session at the termination of the interactive session.

According to some examples, a request to confirm whether the contents of an interactive session are loaded may be transmitted. In response to the request, interactive session controller cache 210 may provide a Boolean. The Boolean may provide an indication, such as a loading indicator, as to whether the interactive session has been loaded into memory.

In some examples, a request to return a model for the interactive session may be transmitted. In response to the request, the interactive session controller cache 210 may provide the model for the specific interactive session if the interactive session is in memory. If the specific interactive session is not in memory, the interactive session controller cache 210 may provide an empty response or an indication that the specific interactive session is not in memory.

According to some examples, a request for a list of interactive session events may be transmitted. In response to the request, interactive session controller cache 210 may return a list of interactive session events for a specific interactive session if the interactive session is stored in memory. If the specific interactive session is not in memory, the interactive session controller cache 210 may provide an empty response or an indication that the specific interactive session is not in memory.

According to some examples, a request to send content may be transmitted. For example, the request to send content may be transmitted to interactive session service 208. In response to the request, interactive session controller cache 210 may add, or include, logic configured to handle the in-flight view of the content to be transmitted. The interactive session controller cache 210 may include a pending event field, which may provide an indication of the status of the content to be transmitted. For example, when the system 200 receives content 22, the system 200 may generate an interaction window 202 and corresponding interactive session that includes the content 222. A pending message from the system 200 to the user may be provided as part of a call to the interactive session events. An indication of “pending” may be provided in the interactive session and/or interaction window 202 until the pending message is confirmed as “sent” or “failed.” Upon confirmation of “sent” or “failed,” the indication of the status of the message may be updated to correspond to “sent” or “failed.” According to some examples, when the status of the message is “failed,” the indication “failed” may remain in place in the interactive session and a “retry” input may be provided. An input corresponding to the selection of “retry” may cause the same message to be resent with updated time stamps and the previous “failed” message may be removed from the interactive session.

The interactive window 202 may include a plurality of interface components. The interface components may include, for example, header component 212, transcript component 214, input component 216, and predicted response component 218.

Header component 212 may be configured to provide interactive session data, such as the username, interactive session identifier, or the like. The information or data provided by the header component 212 may be specific to the use case of interface 100. For example, if the interface is used in conjunction with sales or customer support, header component 212 may include order information.

Transcript component 214 may be configured to access, read, and/or bound to interactive session cache, e.g, interactive session controller cache 210. According to some examples, transcript component 214 may be configured to register renderers for each event type. For example, for a content event the transcript component 214 may be configured to render content. When an interactive window is generated, transcript component 214 may be configured to render an identification of the participants within the interaction session, e.g., the user, the agent, or the like. When a participant leaves the interactive session, transcript component 214 may be configured to render an identification of the participants who have left the interactive session.

Input component 216 may be configured to receive content to be transmitted to a user as part of the interactive session. According to some examples, input component 216 may be configured to call interactive session cache, e.g., interactive session controller cache 210, when an agent or the AI model transmits content to a user. The input component 216 may be configured to toggle between shareable content, such as emojis, attachments, predicted responses, spelling and grammar check, manual input from the agent, or the like. According to some examples, system 200 may disable input component 216 when there is a pending message from the agent and/or AI model to the user.

Predicted response component 218 may be configured to provide a generated, or predicted, response to content 222 received from the use. The predicted response component 218 may be bound to conversation cache, e.g., interactive session controller cache 210, such that predicted responses provided by predicted response component 218 may be appended to draft messages.

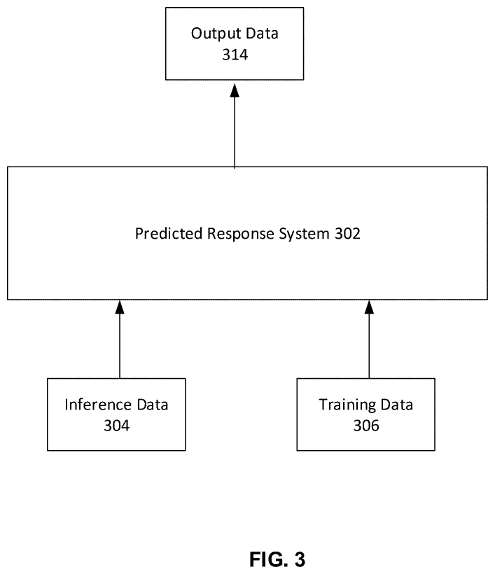

FIG. 3 illustrates a block diagram of an example predicted response system 302, which can be implemented on one or more computing devices. According to some examples, the predicted response system 302 may be generative AI. The predicted response system 302 can be configured to receive inference data 304 and/or training data 306 for use in generating predicted responses in response to content received from a user during an interactive session. The predicted responses may be provided in response to content received from the user. For example, when executing the predicted response system 302, the content received from the user may be provided as input and a predicted response may be provided as output. The predicted response may be a generative response based on the content. The predicted response may have a conversational tone, such that there is a question and answer type electronic communication session among the user and the predicted response system 302.

According to some examples, the predicted response system 302 can receive the inference data 304 and/or training data 306 as part of a call to an application programming interface (API) exposing the predicted response system 302 to one or more computing devices. Inference data 304 and/or training data 306 can also be provided to the predicted response system 302 through a storage medium, such as remote storage connected to the one or more computing devices over a network. Inference data 304 and/or training data 306 can further be provided as input through a user interface on a client computing device coupled to the

The inference data 304 can include data associated with predicting responses to content as part of a plurality of concurrent interactive sessions. The inference data 304 may include content, such as event data, context data, or the like, associated with interactive sessions. In some examples, the inference data 304 may include source text of the interactive sessions as well as metadata for the source text, such as timestamp, event type, interventions, or the like.

The training data 306 can correspond to an artificial intelligence (AI) task, such as a ML task, for predicting responses to content received from a user, such as a task performed by a neural network. The training data can be split into a training set, a validation set, and/or a testing set. An example training/validation/testing split can be an 80/10/10 split, although any other split may be possible. The training data 306 can include example responses for certain content received from users. For example, if the content received from the user is a request for a status update on their order, the example responses may be “Can you please provide your order number?” or “I am happy to help you find that.” The training data 306 may be based on previous interactive sessions among users, agents, the predicted response system 302, and/or other AI models. For example, the content of completed, or terminated, interactive sessions may be provided as training data 306 for the predicted response system 302. The predicted response system may identify example responses, based on previously provided predicted responses and/or manual input from the agent, provided based on the content received from the user.

The training data 306 can be in any form suitable for training a model, according to one of a variety of different learning techniques. Learning techniques for training a model can include supervised learning, unsupervised learning, and semi-supervised learning techniques. For example, the training data can include multiple training examples that can be received as input by a model. The training examples can be labeled with a desired output for the model when processing the labeled training examples. The label and the model output can be evaluated through a loss function to determine an error, which can be backpropagated through the model to update weights for the model. For example, if the machine learning task is a classification task, the training examples can be images labeled with one or more classes categorizing subjects depicted in the images. As another example, a supervised learning technique can be applied to calculate an error between outputs, with a ground-truth label of a training example processed by the model. Any of a variety of loss or error functions appropriate for the type of the task the model is being trained for can be utilized, such as cross-entropy loss for classification tasks, or mean square error for regression tasks. The gradient of the error with respect to the different weights of the candidate model on candidate hardware can be calculated, for example using a backpropagation algorithm, and the weights for the model can be updated. The model can be trained until stopping criteria are met, such as a number of iterations for training, a maximum period of time, a convergence, or when a minimum accuracy threshold is met.

From the inference data 304 and/or training data 306, the predicted response system 302 can be configured to output one or more results related to providing a generative predicted response to content received from users during an interactive session. The predicted response may be generated as output data 314. As examples, the output data 314 can be any kind of score, classification, or regression output based on the input data. Correspondingly, the AI or machine learning task can be a scoring, classification, and/or regression task for predicting some output given some input. For example, the predicted response system 302 may predict a response given the input, e.g., content from a user. These AI or machine learning tasks can correspond to a variety of different applications in processing images, video, text, speech, or other types of data to provide an efficient and effective conversational experience among a user, an agent, and the predicted response system 302.

As an example, the predicted response system 302 can be configured to send the output data 314 for display on a client or user display. For example, the output data 314 may be provided for display on interface 100. As another example, the predicted response system 302 can be configured to provide the output data 314 as a set of computer-readable instructions, such as one or more computer programs. The computer programs can be written in any type of programming language, and according to any programming paradigm, e.g., declarative, procedural, assembly, object-oriented, data-oriented, functional, or imperative. The computer programs can be written to perform one or more different functions and to operate within a computing environment, e.g., on a physical device, virtual machine, or across multiple devices. The computer programs can also implement functionality described herein, for example, as performed by a system, engine, module, or model. The predicted response system 302 can further be configured to forward the output data 314 to one or more other devices configured for translating the output data into an executable program written in a computer programming language. The predicted response system 302 can also be configured to send the output data 314 to a storage device for storage and later retrieval.

The predicted response system 302 may provide predicted responses to be transmitted to a user in response to content received from the user. The predicted responses provided as output data 314 may be automatically transmitted after a threshold period of time if a manual input from the agent is not received. For example, after the predicted response system 302 provides the predicted response to the content as output data 314 an agent may review or otherwise provide an input overriding the predicted response. A threshold period of time may be set for the agent to intervene with the predicted response. After the threshold period of time elapses, the predicted response may be automatically transmitted to the user in response to the content.

The threshold period of time may, therefore, be a buffer period of time that prevents the AI system from having full control over the interactive sessions. In some examples, the threshold period of time allows agents to intervene to prevent the interactive sessions from being purely automated. The threshold period of time may, in some examples, be determined on an agent by agent basis. For example, the threshold period of time may be determined on a per agent basis based on one or more variables. The variables may include, for example, the number of concurrent interactive sessions the agent is engaged with, the time that has elapsed between communications within the interactive sessions, the number of communications transmitted and/or received within the interactive session, the type of issue the agent is handling within the interactive session, etc. In some examples, the threshold period of time may be determined for a plurality of agents, all agents, etc. For example, the threshold period of time may be determined based on the variables for the plurality of agents. According to some examples, the threshold period of time may be determined using an AI model trained to optimize the threshold period of time.

By using the predicted response system 302 and automatically transmitting the output data 314 if a manual input from the agent is not received within the threshold period of time, the computational efficiency of the system may be increased by requiring fewer manual inputs from the agent. For example, the predicted response system 302 may generate responses to be transmitted without requiring input from the agent. This increases computational efficiency by reducing the number of inputs required to engage with a user which decreases the amount of processing and network overhead associated with the interactive session. Further, a predicted response that is generated based on inference data 304 and training data 306 that is continuously updated based on terminated interactive sessions means that fewer inputs are required to have an efficient and effective interactive session. Further the network and processor overhead associated with subsequent manual inputs from the agent is reduced.

In some examples, using the predicted response system 302 and automatically transmitting the output data 314 if a manual input from the agent is not received within the threshold period of time, the computational efficiency of the system may be increased by requiring fewer computer systems to execute the predicted response system 302, and the like. In particular, the predicted response system 302 may provide for a single agent to oversee multiple interactive sessions in a single interface as compared to having each individual interactive session on a respective computer system.

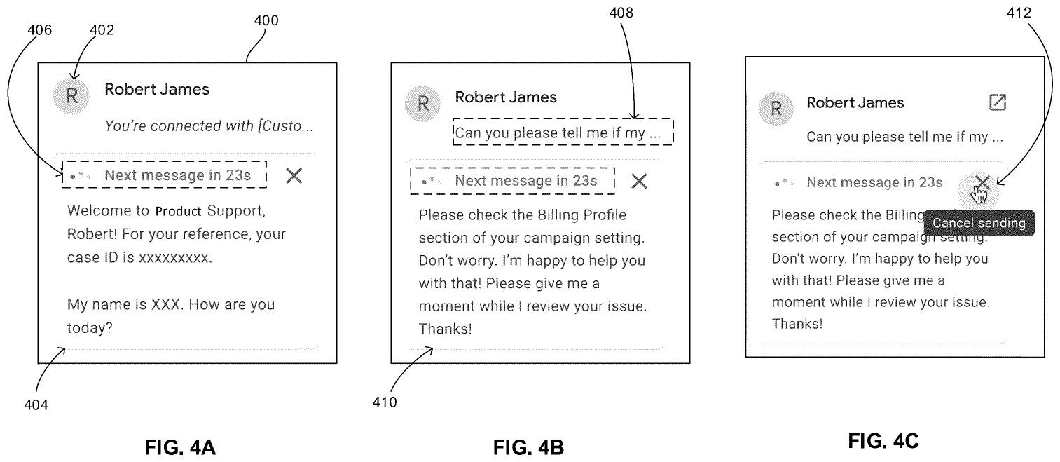

FIGS. 4A-4C are example screenshots illustrating predicted responses as part of an interactive session. Interactive session 400 may be an electronic communication session among a user, e.g., Robert James, an agent, and one or more AI models, such as predicted response system 302. The interactive session 400 may be generated in response to receiving content from the user. The interactive session 400 may include a header which includes the user's name, an indicator 402, and/or other data related to the interactive session 400.

After generating the interactive session 400, predicted response system 302 may generate a predicted response 404. The predicted response 404 may be based on the content received from the user. For example, in response to a request to establish the interactive session 400, the predicted response system 302 may provide, as output, a predicted response 404 welcoming the user to the interactive session 400.

According to some examples, the predicted response 404 may include a timer element 406. The timer element 406 may provide an indication of the amount of time remaining in the threshold period of time before the predicted response 404 is automatically transmitted to the user. For example, the timer element 406 may provide a real-time countdown of the time remaining before the predicted response 404 is automatically transmitted to the user. If a manual input from the agent is not received before the timer element 406 elapses, or reaches zero, the predicted response may be automatically transmitted to the user as part of the interactive session 400.

As illustrated in FIG. 4B, the predicted response 410 may be generated in response to the content 408 received from the user. The predicted response system 302 may, therefore, be generative AI that can adapt and provide an output corresponding to the input, e.g., content 408.

According to some examples, as illustrated in FIG. 4C, the system may receive an input corresponding to the section of cancel sending input 412. The input may be, for example, a manual input from the agent. In response to receiving the manual input from the agent, e.g., the selection of cancel sending input 412, the system may prevent the predicted response 410 from being automatically transmitted to the user. Rather, in response to the selection of cancel sending input 412, the system may provide an input to receive additional input from the agent, such as text, image, emoji, attachments, or the like.

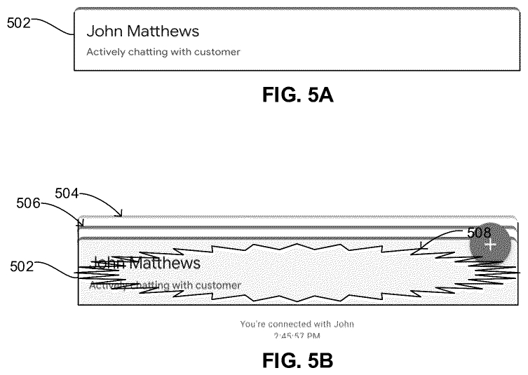

FIGS. 5A and 5B are example screenshots illustrating how interactive sessions may be provided for display in the chat panel 104. FIG. 5A illustrates a single interactive session 502. The portion of the interactive session 502 visible in the chat panel 104 may be, for example, the header, such as the header shown in FIG. 5A. In some examples, the portion of the interactive session visible in the chat panel 104 may be the header and the content being transmitted between the user, agent, and the AI.

FIG. 5B illustrates a portion of the chat panel in which an agent is concurrently supervising multiple interactive sessions 502, 504, 506. According to some examples, an AI model may identify whether to transmit a notification to the agent. The request for agent intervention may be transmitted in response to content received from the user. For example, if the content received from the user includes a request to speak to a human or an agent, a request for information that cannot be provided by the predicted response system 302, a request for information that cannot be generated by the predicted response system 302, or the like, a notification may be transmitted to the agent.

The AI model may, in some examples, be a separate, or different, AI model than the predicted response system 302. The AI model may identify whether to transmit a notification to the agent based on the content received from the user. According to some examples, the AI model may be trained to predict the likelihood the agent could, would, and/or should intervene based on historical examples of similar cases. When the likelihood is above a threshold, a notification may be transmitted to alert the agent. For example, the system may receive content requesting to speak to the agent directly. In such an example, the ML may generate the notification for the interactive session. As shown in FIG. 5B, the notification may be a visible notification 508, such as a flashing or blinking of the header of the interactive session 502. In some examples, the visible notification 508 may cause the coloring of the interactive session 502 to change colors. The notification may, additionally or alternatively, be an audible notification, such as a ping, ding, beep, or the like. According to some examples, the audible and/or visual notification may continue until the system receives an input corresponding to the selection of the interactive session 502.

The notification may correspond to a request for agent intervention. Agent intervention may be, for example, one or more manual inputs from the agent in response to the content received from a user rather than the predicted response. By transmitting an audible and/or visible notification, the agent's attention may be drawn to a given interactive session, e.g., interactive session 502. This may allow the agent to supervise multiple interactive sessions concurrently.

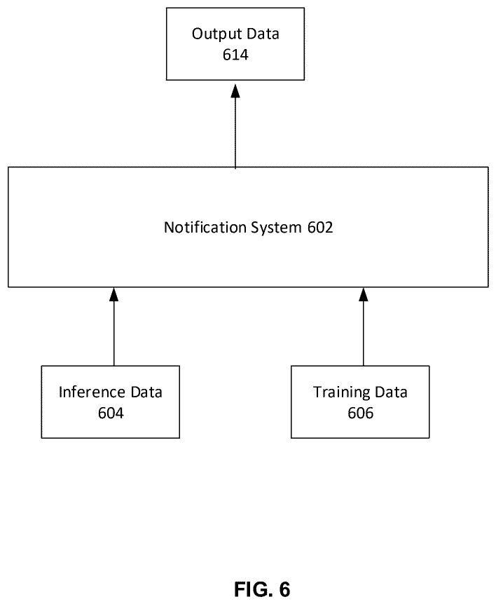

FIG. 6 depicts a block diagram of an example notification system 602, which can be implemented on one or more computing devices. The notification system 602 can be configured to receive inference data 604 and/or training data 606 for use in identifying whether to transmit a notification. Whether to generate and/or transmit a notification may be determined based on the content received from the user. For example, when executing the notification system 602, the content received from the user may be provided as input and a determination as to whether to provide a notification may be provided as output. The system may, based on the determination of the notification system 602, may generate and/or transmit a notification to the interface 100. The notification may alert an agent to provide manual inputs, instead of the predicted response. The notification may be an audible and/or visible notification. In some examples, such as when the system is executed in a mobile device, e.g., a smart phone, tablet, or the like, the notification may be a haptic notification.

According to some examples, the notification system 602 can receive the inference data 604/or training data 606 as part of a call to an application programming interface (API) exposing the notification system 602 to one or more computing devices. Inference data and/or training data can also be provided to the notification system 602 through a storage medium, such as remote storage connected to the one or more computing devices over a network. Inference data and/or training data can further be provided as input through a user interface on a client computing device coupled to the notification system 602.

The inference data 604 can include data associated with identifying whether to transmit a notification. According to some examples, the inference data 604 may include content from interactive sessions. The content may include, for example, source text of the interactive sessions as well as metadata for the source text, such as timestamp, event types, or the like.

The training data 606 can correspond to an artificial intelligence (AI) task, such as a ML task, for determining whether to transmit a notification, such as a task performed by a neural network. The training data can be split into a training set, a validation set, and/or a testing set. An example training/validation/testing split can be an 80/10/10 split, although any other split may be possible. The training data 606 can include examples for when a notification should be transmitted. For example, a notification should be transmitted if the content received from the user includes a request to speak to a human or an agent, a request for information that cannot be provided by the predicted response system 302, or the like.

The training data 606 can be in any form suitable for training a model, according to one of a variety of different learning techniques. Learning techniques for training a model can include supervised learning, unsupervised learning, and semi-supervised learning techniques. For example, the training data 606 can include multiple training examples that can be received as input by a model. The training examples can be labeled with a desired output for the model when processing the labeled training examples. The label and the model output can be evaluated through a loss function to determine an error, which can be backpropagated through the model to update weights for the model. For example, if the machine learning task is a classification task, the training examples can be images labeled with one or more classes categorizing subjects depicted in the images. As another example, a supervised learning technique can be applied to calculate an error between outputs, with a ground-truth label of a training example processed by the model. Any of a variety of loss or error functions appropriate for the type of the task the model is being trained for can be utilized, such as cross-entropy loss for classification tasks, or mean square error for regression tasks. The gradient of the error with respect to the different weights of the candidate model on candidate hardware can be calculated, for example using a backpropagation algorithm, and the weights for the model can be updated. The model can be trained until stopping criteria are met, such as a number of iterations for training, a maximum period of time, a convergence, or when a minimum accuracy threshold is met.

From the inference data 604 and/or training data 606, the notification system 602 can be configured to output one or more results related to whether a notification should be generated as output data 614. As examples, the output data 614 can be any kind of score, classification, or regression output based on the input data. The input data may be, for example, the content received from the user. Correspondingly, the AI or machine learning task can be a scoring, classification, and/or regression task for predicting some output given some input. These AI or machine learning tasks can correspond to a variety of different applications in processing images, video, text, speech, or other types of data to determine whether to generate and/or transmit a notification. The output data 614 can include instructions associated with generating and/or transmitting a notification.

As an example, the notification system 602 can be configured to send the output data 614 for display on a client or user display. For example, if notification system 602 determines that a notification should be provided, a visible notification may be provided as output data 614 for display on a display. In some examples, the notification may be an audible notification such that the notification may be provided as output data 614 via one or more outputs, such as speakers. As another example, the notification system 602 can be configured to provide the output data 614 as a set of computer-readable instructions, such as one or more computer programs. The computer programs can be written in any type of programming language, and according to any programming paradigm, e.g., declarative, procedural, assembly, object-oriented, data-oriented, functional, or imperative. The computer programs can be written to perform one or more different functions and to operate within a computing environment, e.g., on a physical device, virtual machine, or across multiple devices. The computer programs can also implement functionality described herein, for example, as performed by a system, engine, module, or model. The notification system 602 can further be configured to forward the output data 614 to one or more other devices configured for translating the output data 614 into an executable program written in a computer programming language. The notification system 602 can also be configured to send the output data 614 to a storage device for storage and later retrieval.

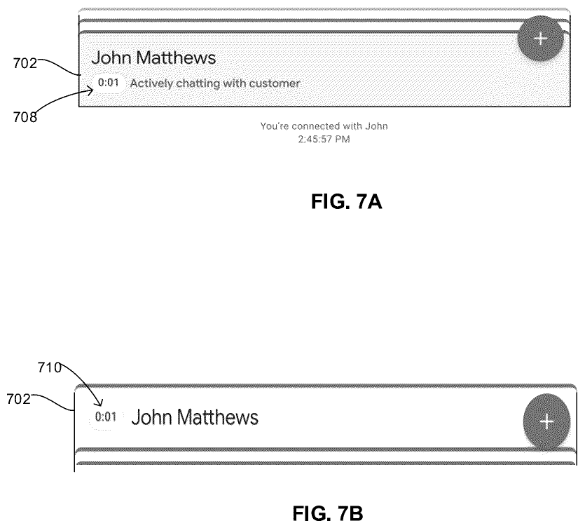

FIGS. 7A and 7B are screenshots of example interactive sessions. The header of the interactive session 702 may include information or data relating to the interactive session. For example, the header may include an indication of the user participating in the interactive session 702, e.g., John Matthews, a timer 708, a status of the interactive session, or the like. The status of the interactive session may be, for example, actively chatting with the user, interactive session timed out, waiting for user content, or the like. In some examples, the header of the interactive session may include an identifier, such as a case or order number, a symbol or indicator for the user, color, or the like. The information provided in the header of the interactive session may allow for an agent to easily review the status of the interactive session such that the agent can readily determine whether intervention is necessary.

As shown in FIG. 7A, interactive session 702 includes a header with timer 708. Timer 708 may begin keeping time upon receipt of content from the user. For example, after the system receives the content from the user, timer 708 may begin tracking the amount of time elapsed since the content was received until the AI model(s) and/or agent responds. After responsive content is transmitted to the user, the time may reset. As shown in FIG. 7B, timer 710 may begin tracking the amount of time that has elapsed since responsive content was transmitted to the user. The responsive content may be, in some examples, a predicted response generated by the predicted response system 302 and/or manual input from the agent.

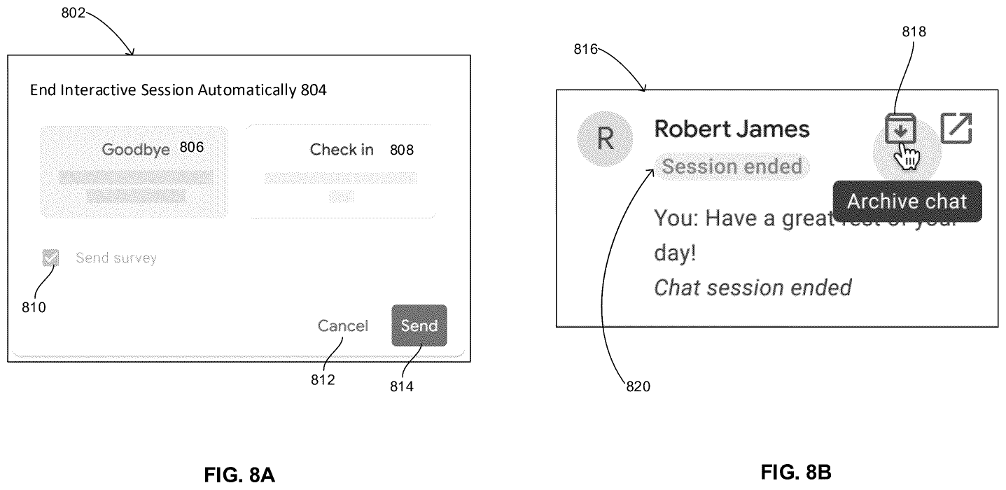

FIGS. 8A and 8B are screenshots of example interactive sessions that are ending. As shown in FIG. 8A, as part of the interactive session 802, the predicted response system 302 may provide a predicted response 804 to end the interactive session. The predicted response 804 may be generated based on the content received from the user, e.g., an indication that there is nothing else the agent can help with. The predicted response 804 may include one or more inputs that can be selected, altered, etc. before the predicted response 804 is transmitted to the user. For example, the inputs may include a “goodbye” input 806, in which a predetermined goodbye response is transmitted to the user. The inputs may include a “check in” input 808, in which a predetermined response asking if there is anything else the agent can help with is transmitted to the user. The inputs may, in some examples, include an option to send a survey 810. The survey may ask questions relating to the user's satisfaction with the interactive session. There may, in some examples, be an input to cancel 812 the predicted response 804 and/or send 814 the selected portions of the predicted response 804.

Based on the inputs received, the system may provide the predicted response to the user, as shown in FIG. 8B. For example, the system may have received an input corresponding to the selection of the “goodbye” input 808 and send survey 810. The predicted responses may be transmitted to the user and, therefore, become part of the transcript of the interactive session 816 after receiving a selection corresponding to the send input 814. According to some examples, based on the inputs received, the status 820 of the interactive session may be updated. For example, in response to receiving an input corresponding to the selection of the “goodbye” input 806, the status 820 of the interactive session 816 may be updated to “session ended.”

According to some examples, after the interactive session 816 has ended, an archive chat input 818 may be provided for output to the agent. In response to an input corresponding to the selection of “archive chat,” and after confirming the user has provided authorization, the contents of the interactive session may be stored and/or tracked. In some examples, archiving chat may include providing the contents of the interactive session as training data and/or inference data for the predicted response system 302 and/or notification system 602.

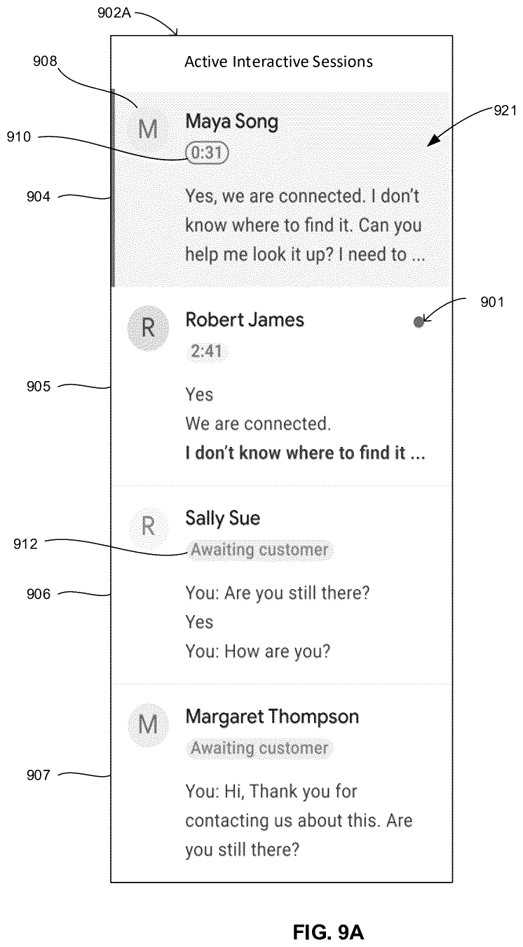

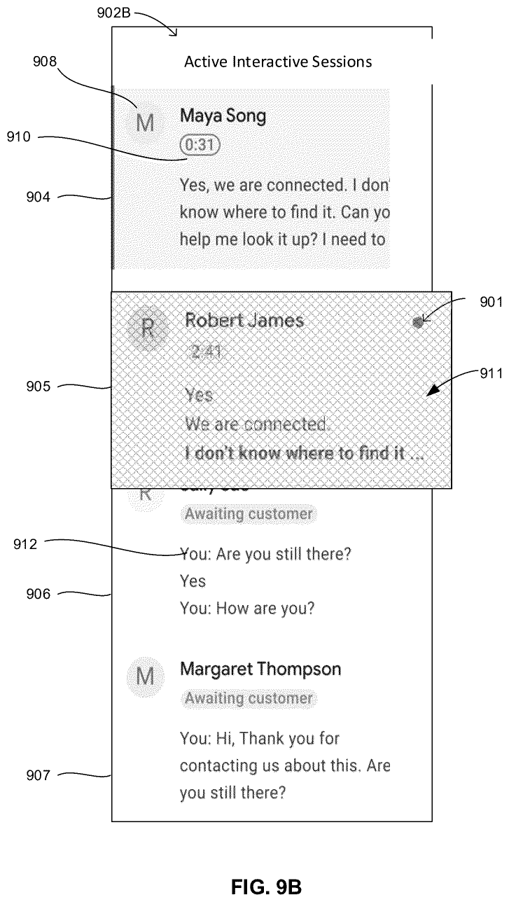

FIG. 9A is an example screenshot of the interaction window panel. The interaction window panel 902A may include multiple interactive windows corresponding to multiple interactive sessions 904-907. The interactive sessions 904-907 may be occurring concurrently and overseen by a single agent. Each interactive window and, therefore, each interactive session may include an indicator, such as indicator 908, identifying the user. The indicators 908 may be color coded, include letters, numbers, or symbols, or may include any other identifying information that allows for an agent to distinguish between the interactive sessions 904-907.

According to some examples, an interactive session may be highlighted. For example, interactive session 904 may be highlighted 921. The highlight 921 may be, for example, a shading, color saturation, or any visual indication that indicates that the interactive session 904 is currently selected. The highlighted interactive session may indicate an interactive session that the agent is currently engaging with.

In some examples, one or more interactive sessions 904-907 may include an indicator 901. The indicator may provide an indication that content was recently received from a user. In some examples, the indicator 901 may correspond to a notification that the agent should intervene in the interactive session.

The interactive sessions may include a timer 910. The timer 910 may provide an indication of how much time has elapsed since content was received from the user. In some examples, the timer may provide an indication of how much time has elapsed since responsive content was transmitted to the user.

In some examples, the interactive sessions may include a status indicator 912. The status indicators 912 may provide an indication of what is happening in the interactive session, whether the user is waiting for responsive content, whether the agent and/or AI model(s) is waiting for content from the user, whether the interactive session is active or terminated, or the like. For example, as shown, the indicator 912 shows that the agent and/or AI model(s) is waiting to receive content from the user.

FIG. 9B is an example screenshot of the interaction window panel. The interaction window panel 902B is substantially similar to the interactive window panel 902A. The interaction window panel 902B further includes an additional, or alternative, visual indication of the notification to the user. For example, interactive session 905 includes indicator 901 indicating that content was received from the user. The indicator 901 may, in some examples, indicate that the agent should intervene in the interactive session based on the content received from the user. As shown, interactive session 905 may include an additional visual indication notifying the agent to intervene. For example, interactive session 905 may include shading 911. The shading 911 may, in some examples, be highlighting, color saturation, flashing, or the like. The shading 911 may correspond to a notification to the agent, notifying the agent that intervention in the interactive session 905 may be necessary. According to some examples, in response to a selection of interactive session 905, the shading 911 may disappear. In some examples, in response to the selection of interactive session 905, the shading 911 may become similar to highlight 921.

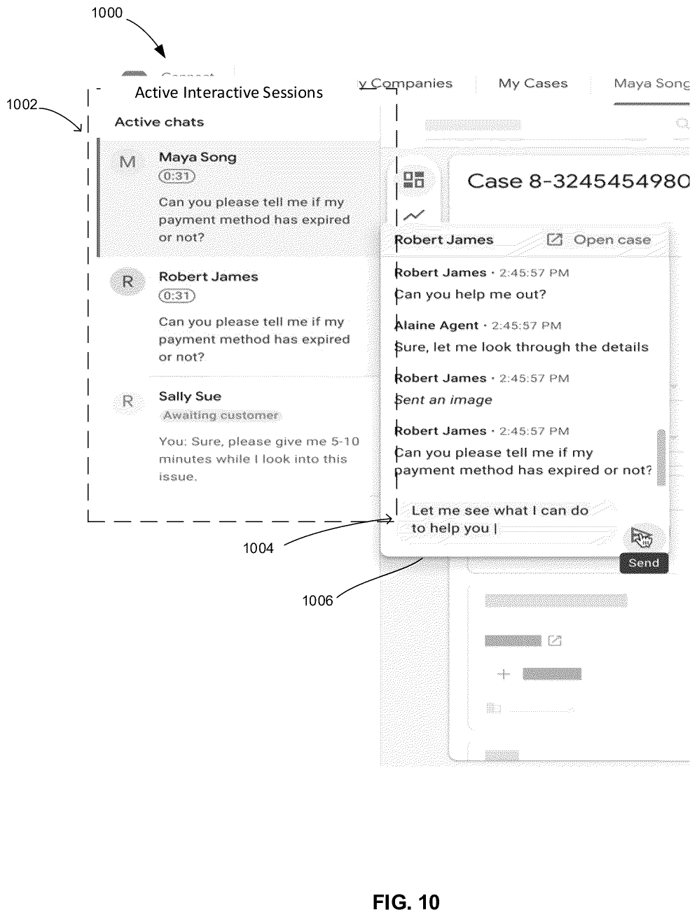

FIG. 10 is an example screenshot of an interface for concurrent interactive sessions. The interface 1000 may include an interaction window panel 1002. Within the interaction window panel may be one or more interaction windows, where each interaction window is generated in response to receiving content from a respective user. Each interaction window may correspond to an interactive session with the respective user.

According to some examples, in response to receiving an input corresponding to a selection of an interactive session in the interaction window panel 1002, a popup 1004, or overlay, of the interaction session may be provided for display on the interface 1000. The pop-up 1004 may include one or more inputs, such as input 1006, that is configured to receive manual inputs from the agent. The manual inputs from the agent may include an input to compose and send content within the pop-up 1004, an input to scroll through the contents of the interactive session, or the like.

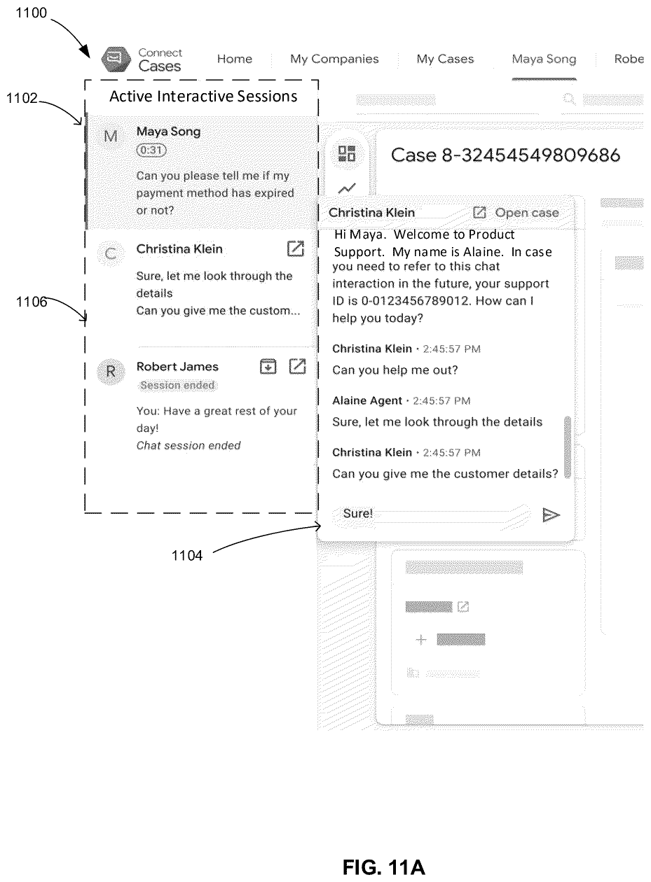

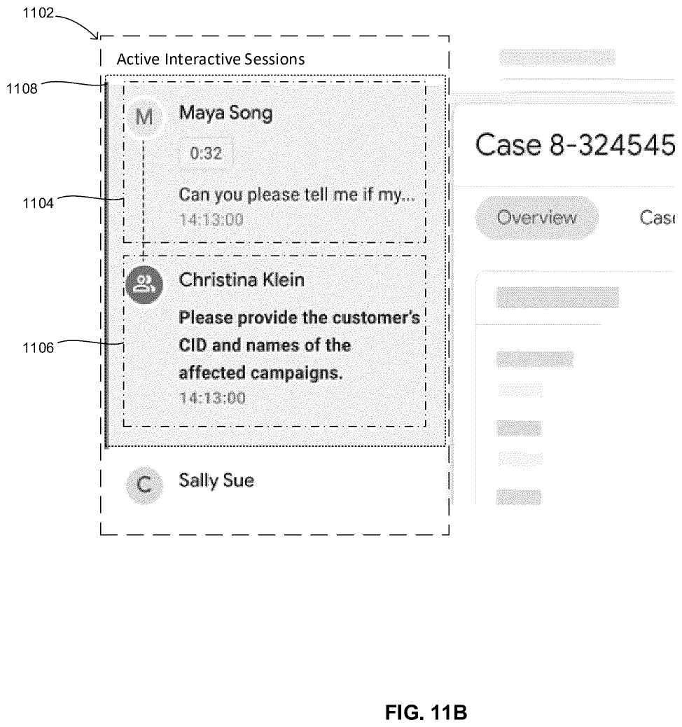

FIG. 11A is an example screenshot of an interface for concurrent interactive sessions. Similar to interface 1000, interface 1100 may include an interaction window panel 1102 and a pop-up 1104 corresponding to an interactive session 1106 selected from the interaction window panel 1102. The selected interactive session 1106 may be a consulting interactive session. A consulting interactive session 1106 may be an interactive session between two agents. For example, the consulting interactive session 1106, as shown in FIG. 11, is between Alaine Agent and Christina Klein. As shown, Christina Klein has requested a consult from Alaine Agent regarding a request from Maya Song.

After the consulting interactive session 1106 is established, the consulting interactive session 1106 may be linked to the interactive session 1104 associated with the consult. For example, as shown in FIG. 11B, interactive session 1104 between Maya Song, the agent, and the AI model(s) may be linked and/or associated 1108 with consulting interactive session 1106. By linking 1108 the interactive session 1106 with consulting interactive session 1106, the agent may be able to easily identify when a response is provided to the consultant such that the information may then be provided to the user.

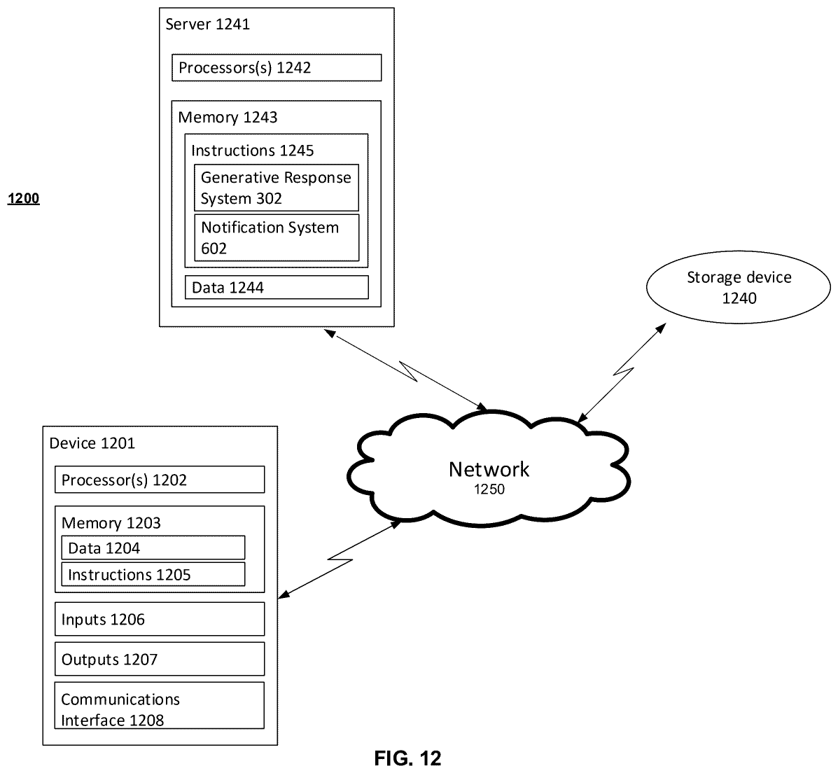

FIG. 12 depicts a block diagram of an example environment 1200 for implementing multiple interactive sessions concurrently. Implementing multiple interactive sessions concurrently on a single interface may include implementing a predicted response system 302 and a notification system 602. The predicted response system 302 and/or notification system 602 can be implemented on one or more devices having one or more processors in one or more locations, such as in server computing device 1241. Client computing device 1201 and the server computing device 1241 can be communicatively coupled to one or more storage devices 1240 over a network 1250. The storage devices 1240 can be a combination of volatile and non-volatile memory and can be at the same or different physical locations than the computing devices. For example, the storage devices 1240 can include any type of non-transitory computer readable medium capable of storing information, such as a hard-drive, solid state drive, tape drive, optical storage, memory card, ROM, RAM, DVD, CD-ROM, write-capable, and read-only memories.

The server computing device 1241 can include one or more processors 1242 and memory 1243. The memory 1243 can store information accessible by the processors 1242, including instructions 1245 that can be executed by the processors 1242. The memory 1243 also includes data 1244 that can be retrieved, manipulated, or stored by the processors 1242. The memory 1243 can be a type of non-transitory computer readable medium capable of storing information accessible by the processors 1242, such as volatile and non-volatile memory. The processors 1242 can include one or more central processing units (CPUs), graphic processing units (GPUs), field-programmable gate arrays (FPGAs), and/or application-specific integrated circuits (ASICs), such as tensor processing units (TPUs).

The instructions 1245 can include one or more instructions that, when executed by the processors 1242, cause the one or more processors 1242 to perform actions defined by the instructions 1245. The instructions 1245 can be stored in object code format for direct processing by the processors, or in other formats including interpretable scripts or collections of independent source code modules that are interpreted on demand or compiled in advance. The instructions 1245 can include instructions for implementing a predicted response system 302 and/or notification system 602, which can correspond to the predicted response system 302 of FIG. 3 and the notification system 602 of FIG. 6. The predicted response system 302 and/or notification system 602 can be executed using the processors 1242, and/or using other processors remotely located from the server computing device 1241.

The data 1244 can be retrieved, stored, or modified by the processors 1242 in accordance with the instructions 1245. The data 1244 can be stored in computer registers, in a relational or non-relational database as a table having a plurality of different fields and records, or as JSON, YAML, proto, or XML documents. The data 1244 can also be formatted in a computer-readable format such as, but not limited to, binary values, ASCII, or Unicode. Moreover, the data 1244 can include information sufficient to identify relevant information, such as numbers, descriptive text, proprietary codes, pointers, references to data stored in other memories, including other network locations, or information that is used by a function to calculate relevant data.

The client computing device 1201 can also be configured similarly to the server computing device 1201, with one or more processors 1202, memory 1203, instructions 1205, and data 1204. The client computing device 1201 can also include a user input 1206, a user output 1207, and a communications interface 1208. The user input 1206 can include any appropriate mechanism or technique for receiving input from a user, such as keyboard, mouse, mechanical actuators, soft actuators, touchscreens, microphones, and sensors. The inputs 1206 may receive images, natural language inputs, or the like for input into the predicted response system 302 and/or notification system 602.

The server computing device 1241 can be configured to transmit data to the client computing device 1201, and the client computing device 1201 can be configured to display at least a portion of the received data on a display implemented as part of the user output 1207. The user output 1207 can also be used for displaying an interface between the client computing device 1201 and the server computing device 1241. For example, the output 1207 may be a display, such as a monitor having a screen, a touchscreen, a projector, or a television, configured to electronically display information to a user via a graphical user interface (“GUI”) or other types of user interfaces. For example, output 1207 may electronically display the output of the predicted response system 302 and/or notification system 602, such as predicted responses and/or notifications, respectively. The user output 1207 can alternatively or additionally include one or more speakers, transducers or other audio outputs, a haptic interface or other tactile feedback that provides non-visual and non-audible information to the platform user of the client computing device.

Device 1201 may be at a node of network 1250 and capable of directly and indirectly communicating with other nodes of network 1250. Although a single device 1201 is depicted in FIG. 12, it should be appreciated that a typical system can include one or more computing devices 1201, with each computing device being at a different node of network 1250.

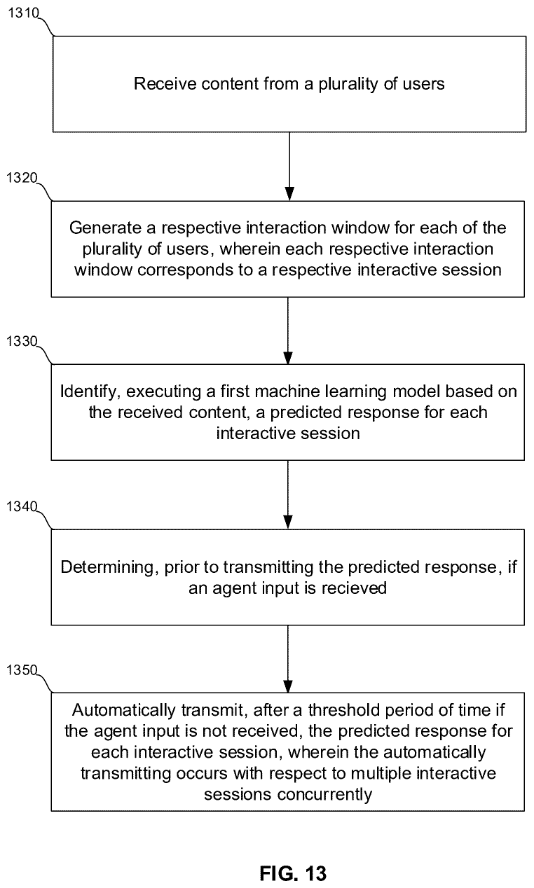

FIG. 13 depicts a flow diagram for concurrently hosting and engaging in multiple interactive sessions. The example process can be performed, at least in part, on a system of one or more processors in one or more locations, such as the predicted response system 302 of FIG. 3 and/or the notification system 602 of FIG. 6. The following operations do not have to be performed in the precise order described below. Rather, various operations can be handled in a different order or simultaneously, and operations may be added or omitted.

In block 1310, content from a plurality of users is received. The content may be, for example, natural language inputs, such as text, images, documents, or the like.

In block 1320, a respective interaction window for each of the plurality of users is generated. Each respective interaction window may correspond to an interactive session. The respective interactive sessions may correspond to an electronic communication session among two or more of a respective user, generative AI, or an agent. The generative AI may, in some examples, be a first machine learning model. In some examples, the respective interactive sessions may be overseen by an agent while content responsive to the content received by the user is generated by the machine learning model. The respective interaction windows and, therefore, interactive sessions for each of the plurality of users may be provided for output on one or more displays coupled to an agent computing device. According to some examples, a visible portion of the respective interaction windows may include a timer and an identifier of the respective user. The timer may provide an indication of an elapsed time since a previous response was transmitted to a respective user or an elapsed time from when content was received from the respective user. The previous response may be the predicted response or the manual input from the agent.

In block 1330, a predicted response for each interaction session may be identified by executing the first machine learning model based on the received content. The first machine learning model may be, for example, the predicted response system 302 of FIG. 3. The predicted response provided by the predicted response system 302 may be responsive to the content received from the user. The predicted response for each interactive session may be different, based on the content received from the respective user. In some examples, the predicted response may be substantially similar but for data related to the user. For example, the predicted response may be a predetermined greeting which is adjusted based on the username, account information, specific request, or the like.

In block 1340, prior to transmitting the predicted response, it is determined if a manual input from the agent is received. For example, the respective interaction window may include a timer element in relation to the predicted response. The timer element may provide an indication of a remaining amount of time of a threshold period of time before the predicted response is automatically transmitted. For example, after the predicted response is identified, the timer element may set a countdown clock corresponding to the threshold period of time. The predicted response may not be automatically transmitted until the expiration of the timer.

In block 1350, if, after the threshold period of time the manual input from the agent is not received, the predicted response for each interactive session may be automatically transmitted. Automatically transmitting the predicted response may occur with respect to multiple interactive sessions concurrently. In this regard, an agent may concurrently supervise the multiple interactive sessions while the predicted response system 302 generates the responsive content to be automatically transmitted to the user.

According to some examples, a second machine learning model may be executed to identify whether to transmit a notification to an agent. The notification may be transmitted via the interface. The notification may be an audible or visual notification. For example, the visual notification may be a change in color, flashing colors, or the like. An audible notification may be a beep, ping, or the like. The notification may correspond to a request for agent intervention. Agent intervention may correspond to one or more manual inputs from the agent in response to the received content from a respective user.

In some examples, the respective interactive session may be terminated by executing the first machine learning model based on the received content. The contents of the respective interactive sessions may be provided as input into the first or second machine learning model. The first or second machine learning model may be updated based on the contents of the respective interactive session. According to some examples, the content of the respective interactive session may include an indication of when the manual input from the agent was transmitted instead of the predicted response.

The use of generative AI, such as the predicted response system 302, may allow for an agent to oversee a plurality of interactive sessions simultaneously as opposed to conducting a single interactive session at a time. The generative nature of the predicted response system 302 provides content responsive to the content received from the user, thereby providing an engaging, efficient, and productive interactive session with little to no manual input from the agent. For example, the predicted response system 302 may automate actions and workflows within the interactive sessions. This may reduce the number of inputs received from an agent, thereby increasing the computational efficiency of the system as a whole. For example, reducing the number of inputs received by the agent may decrease the processing power and network overhead required to engage in multiple interactive sessions concurrently.

Including a threshold period of time before transmitting the generated response prevents the system from being fully automated, such that all actions are performed by the AI models. The threshold period of time, or buffer, avoids the AI models from having full control of the interactive sessions overseen by the agent.

Further, the use of a notification system 602 may reduce the number of inputs received from the agent. For example, by providing an audible or visible notification altering the agent to an interactive session that requires agent intervention, the agent no longer has to click between multiple interactive sessions, windows, browsers, programs, or the like. This may increase the computational efficiency of the system by decreasing the processing power and network overhead required to engage in, or intervene in, multiple interactive sessions concurrently.

According to some examples, by increasing the number of interactive sessions a single agent can oversee concurrently, the computational efficiency of the system may increase by decreasing the number of computer systems required to engage in the same number of interactive sessions where an agent is only capable of overseeing a single interactive session. For example, as the number of concurrent interactive sessions the agent oversees increase, the computational efficiency of the system increases by decreasing the processing power, e.g., reduced number of computer systems, inputs, requests, etc., and decreasing network overhead/

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the examples should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. A method, comprising:
receiving, by one or more processors, content from a plurality of users;
generating, by the one or more processors, a respective interaction window for each of the plurality of users, wherein each respective interaction window corresponds to a respective interactive session;
identifying, by the one or more processors executing a first artificial intelligence model based on the received content, a predicted response for each interactive session;
determining, by the one or more processors prior to transmitting the predicted response, if a manual input from an agent is received; and
automatically transmitting, by the one or more processors after a threshold period of time if the manual input from the agent is not received, the predicted response for each interactive session, wherein the automatically transmitting occurs with respect to multiple interactive sessions concurrently.

2. The method of claim 1, wherein the respective interaction window includes a timer element in relation to the predicted response.

3. The method of claim 2, wherein the timer element provides an indication of a remaining amount of time of the threshold period of time before the predicted response is automatically transmitted.

4. The method of claim 1, wherein the respective interactive session corresponds to an electronic communication session among two or more of a respective user, the first artificial intelligence model, or an agent.

5. The method of claim 1, wherein the respective interaction windows for each of the plurality of users are provided for output on one or more displays coupled to an agent computing device.

6. The method of claim 1, wherein the respective interactive windows are cascaded in a panel of the single display.

7. The method of claim 1, wherein a visible portion of the respective interaction windows includes a timer and an identifier of the respective user.

8. The method of claim 7, wherein the timer provides an indication of an elapsed time since a previous response was transmitted to a respective user or an elapsed time from when content was received from the respective user.

9. The method of claim 8, wherein the previous response is the predicted response or the manual input from the agent.

10. The method of claim 1, further comprising automatically identifying, by the one or more processors executing a second artificial intelligence model, whether to transmit a notification to an agent.

11. The method of claim 10, wherein the notification is an audible or visual notification.

12. The method of claim 10, wherein the notification is a request for agent intervention.

13. The method of claim 12, wherein the agent intervention corresponds to one or more manual inputs from the agent in response to the received content from a respective user.

14. The method of claim 1, further comprising terminating, by one or more processors executing the first artificial intelligence model based on the received content, the respective interactive session.

15. The method of claim 14, further comprising providing, by the one or more processors as input into the first or second artificial intelligence model, contents of the respective interaction session.

16. The method of claim 15, further comprising updating, by the one or more processors based on the contents of the respective interactive session, the first or second artificial intelligence model.

17. The method of claim 15, wherein the contents of the respective interactive session include an indication of when the manual input from the agent was transmitted instead of the predicted response.

18. The method of claim 1, wherein the first artificial intelligence model is a machine learning model or a generative artificial intelligence model.

19. A system, comprising:
one or more processors, the one or more processors configured to:
receive content from a plurality of users;
generate a respective interaction window for each of the plurality of users, wherein each respective interaction window corresponds to a respective interactive session;
identify, by executing a first artificial intelligence model based on the received content, a predicted response for each interactive session;
determine, prior to transmitting the predicted response, if a manual input from an agent is received; and
automatically transmit, processors after a threshold period of time if the manual input from the agent is not received, the predicted response for each interactive session, wherein the automatically transmitting occurs with respect to multiple interactive sessions concurrently.

20. One or more non-transitory computer-readable storage media encoding instructions that, when executed by one or more processors, cause the one or more processors to perform operations comprising:
receiving content from a plurality of users;
generating a respective interaction window for each of the plurality of users, wherein each respective interaction window corresponds to a respective interactive session;
identifying, by executing a first artificial intelligence model based on the received content, a predicted response for each interactive session;
determining, prior to transmitting the predicted response, if a manual input from an agent is received; and
automatically transmitting, processors after a threshold period of time if the manual input from the agent is not received, the predicted response for each interactive session, wherein the automatically transmitting occurs with respect to multiple interactive sessions concurrently.
